(19) United States
(12) Patent Application Publication
(10) Pub. No.: US 2006/0157308 A1
(43) Pub. Date: Jul. 20, 2006

(54) Actuator of a parking brake

(75) Inventors: Gunter Hartig, Herzogenaurach (DE); Manfred Kraus, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 10/568,468

(22) PCT Filed: Jul. 10, 2004
(86) PCT No.: PCT/EP04/07640

§ 371 Date: Mar. 8, 2006

(30) Foreign Application Priority Data
Aug. 14, 2003 (DE) 103 37 801.4
Jun. 26, 2004 (DE) 10 2004 030 939.6

(51) Int. Cl. F16D 65/14

(52) U.S. Cl. 188/265; 188/2 D; 188/162

(57) ABSTRACT

An actuator for a parking brake of a motor vehicle is provided, which includes an electric motor (1) whose rotor (20 has a threaded spindle (3) on which a spindle nut (4) is located. Between the threaded spindle (3) and the spindle nut (4), rolling bodies are in rolling engagement with threaded paths (6, 7) formed on the spindle nut (4) and on the threaded spindle (3). A cable pull (8) for actuating a brake acts upon the spindle nut (4).

### BACKGROUND

The present invention relates to an actuator for a parking brake of a motor vehicle. Parking brakes actuated with an actuator can be set automatically when parking and can be released automatically when starting to move again. These parking brakes can also be designated as active parking brakes.

These usually electromechanical actuators comprise an electric motor, which sets the parking brake via a control element. The control element can comprise gearing. These actuators should enable quick release and application of the parking brake. The objective of the present invention is to provide an actuator of a parking brake for a motor vehicle, which has a simple design and can be actuated reliably.

### SUMMARY

The actuator according to the invention from claim 1 has the advantage that the rotor of the electric motor drives the threaded spindle directly, so that gearing between the rotor and the threaded spindle is eliminated. The known spindle nuts arranged on the threaded spindle operate with very low friction, because relative rotation between the spindle nut and the threaded spindle is performed with the rolling of rolling bodies on threaded paths of the spindle nut and the threaded spindle. The combination of the direct drive and rolling body threaded drive enables a drive with very high mechanical efficiency. The spindle nut interacting with the threaded spindle form a known rolling body threaded drive, which operates reliably. The actuator according to the invention has a compact and economic design due to the elimination of intermediate gearing. Due to the low friction losses, the electric motor can be small.

The spindle nut is displaced in the axial direction when the threaded spindle rotates, because a rolling body threaded drive represents a rotary transmission gearing. The cable pull attached to the spindle nut is tightened by the axial displacement of the spindle nut through tensioning. Loosening is realized through an opposite movement of the spindle nut.

The actuator according to the invention enables a biasing force of about 1600 N per wheel side. The tension path—thus the travel path of the spindle nut—can equal approximately 25 mm. The activation time can be reduced to about 700 milliseconds at a spindle rpm of approximately 1250 revolutions/min. Quick activation times are therefore possible.

If the parking brake is activated, thus the actuator has been set, the vehicle is secured. If there is not a self-locking gear between the electric motor and the cable pull, then a locking device can be provided, which secures the rotor and/or the threaded spindle against rotation. This locking can be realized preferably in a mechanical way, for example, through positive-fit meshing of locking elements, of which one is fixed in rotation on the rotor and the other is fixed in the rotational directions of the rotor. For example, a displaceable piston can engage in a gap of a gear defined by teeth. The tensile load of the cable pull can exert a torque on the threaded spindle or the rotor. This torque is then received by the locking device. In the case of the piston, a tooth then presses against the piston. The piston is then held tight and rotation of the spindle nut is stopped.

If the parking brake is to be released, first the cable pull is relaxed by actuating the electric motor, which has the result that the piston is no longer held tight. If a spring force is applied to the piston, the piston can be moved out from its locking position under this spring force. The parking brake is then released.

If the parking brake is to be released, but the electric motor cannot be used due to loss of power, an emergency unlocking device is provided. With this emergency unlocking device, which can be operated, for example, by hand, the locking device can be disabled. For the locking device described as an example, it is necessary to remove the load of the toothed disk which is pressed against the piston, so that the piston can spring out of its locking position under the spring force. With the emergency locking device, now a torque is exerted by hand, which counteracts a torque exerted by the load of the cable pull. This means that the pressure is taken off the piston, so that the piston can spring out. The parking brake is then released.

If, for example, the emergency unlocking device has a band, which wraps around the toothed disk and which, in the wrap-around area has a pocket, into which the teeth of the toothed disk project, first the toothed disk can rotate without coming into locking contact with the band. If the band is provided with a crosspiece, which can engage in a gap of the toothed disk, the emergency unlocking device can operate as follows. With one end, the band is fixed to a tension spring. At the other end it is now tightened. The band now moves along the periphery of the toothed disk, wherein the crosspiece engages in the gaps. For further movement of the band, the toothed disk is taken along and the piston of the locking device relaxes, so that this piston can spring out from the gap.

### BRIEF DESCRIPTION OF THE DRAWINGS

The invention is explained in more detail below with reference to an embodiment shown in a total of three figures. Shown are:

FIG. 1 a perspective view of an actuator according to the invention for a parking brake of a motor vehicle,

FIG. 2 a longitudinal section view of a part of the actuator according to FIG. 1, and

FIG. 3 another perspective view of the actuator according to the invention from FIG. 1.

### DETAILED DESCRIPTION OF THE PREFERRED EMBODIMENTS

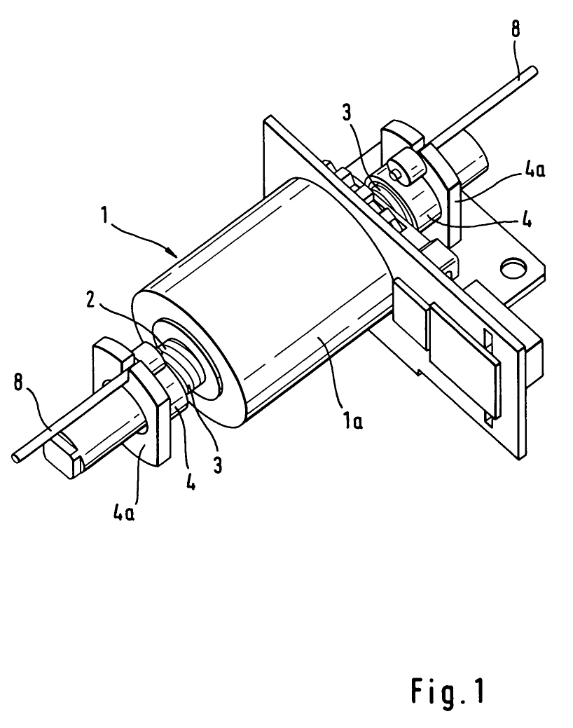

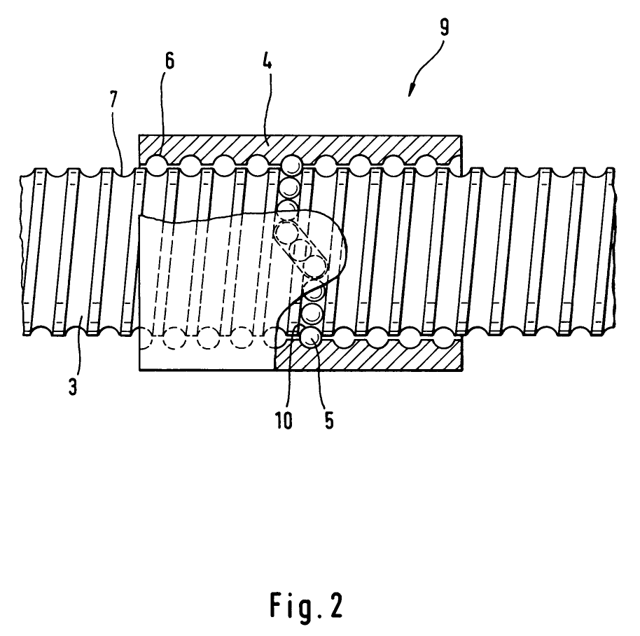

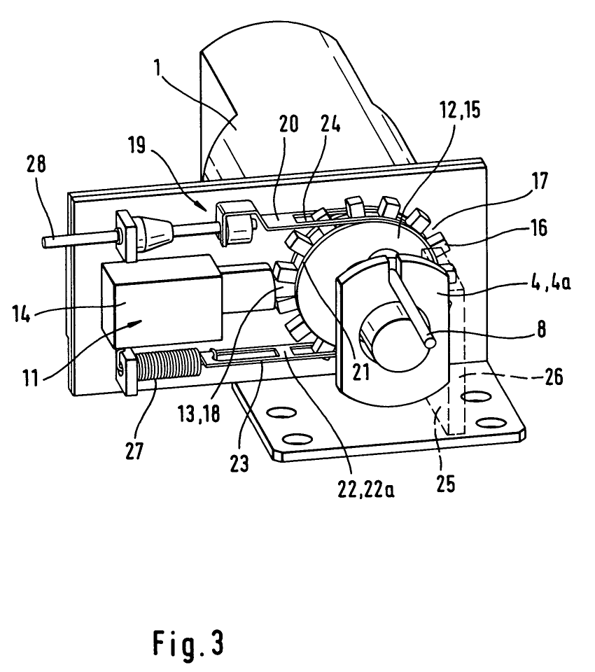

The actuator according to the invention shown in FIGS. 1 and 3 for a parking brake of a motor vehicle is provided with an electric motor 1, having a rotor 2 with a threaded spindle 3. A spindle nut 4 is arranged on the threaded spindle 3. The spindle nut 4 is shown clearly in FIG. 2 in a longitudinal section. It should be noted from FIG. 2 that between the threaded spindle 3 and the spindle nut 4 there are rolling bodies 5 in rolling engagement with threaded paths 6, 7 formed on the spindle nut 4 and the threaded spindle 3. The spindle nut 4 and the threaded spindle 3 form a ball screw 9, wherein the rolling bodies are formed by balls 5a, which circulate in endless ball raceways 10. The ball raceways 10 are defined by the threaded paths 6, 7 of the threaded spindle 3 and the spindle nut 4. The rotor 2 has two opposite ends, which are arranged on two sides of a motor housing 1a of the electric motor 1. One of the threaded spindles 3 is attached to both ends of the rotor 2. This threaded spindle 3 is coaxial to the rotor 2 and locked in rotation with this rotor. These two threaded spindles 3 have threaded path sections of opposing slope. A spindle nut 4 is arranged on each threaded path section. A cable pull support 4a is fixed to each spindle nut 4. Cable pulls 8 are suspended in the two cable pull supports 4a. The cable pulls 8 each engage one of the parking brakes of the motor vehicle. The parking brakes are not shown here. FIG. 3 shows that the cable pull supports 4a are arranged displaceable along a connecting member 26 here shown only with dashed lines. This connecting member 26 is used as a rotational lock for the cable pull supports 4a and the spindle nut 4.

FIG. 3 further shows a locking device 11, which prevents rotation of the rotor 2 and thus of the threaded spindle 3 when no current flows to the electric motor 1. This locking device 11 has a first locking element 12 fixed in rotation with the rotor 2 and a movable second locking element 13, wherein, in the locking position the two locking elements 12, 13 engage with a positive fit in each other for preventing rotation of the rotor 2. The first locking element 12 has a toothed disk 15 locked in rotation with the rotor 2. Several teeth 16 distributed over the extent of the disk form gaps 17 on the periphery of this toothed disk.

The locking device 11 further comprises a frame-fixed electromagnet 14, which is provided with the second locking element 13. The locking element 13 moves into the locking position under the activation of the electromagnet 14, wherein the locking position is reached when the second locking element 13 engages in the gap 17. The second locking element 13 is here formed by a piston 18. The piston 18 is acted on by a spring force and can be pushed against the spring force into the locking position through the activation of the electromagnet 14.

The ball screw 9 forms a control element, which is driven by the rotor 2. Instead of the ball screw, other rotary transmission gears are also possible.

FIG. 3 further shows an emergency unlocking device 19 for relaxing the locking device 11 from a load applied for tensioning the brake.

This emergency unlocking device 19 has a band 20, which is arranged perpendicular to the rotor axis and which wraps around a contact surface 21 arranged coaxial to the rotor axis. This contact surface 21 is formed on the toothed disk 15 and axial to two sides of the teeth 16. The band 20 has legs or belts 23 extended in the longitudinal direction of the band 20, wherein the belts 23 can be brought into contact with the contact surface 21. The two legs or belts 23 define a large pocket 24, which is bordered by a catch 22 along the band. This catch 22 is formed in the present example as a transverse crosspiece 22a, which connects the two belts 23 to each other. One band end is attached to a tension spring 27, which is supported, on its side, by a housing 25 fixed to the frame. The other band end engages a cable pull 28. By tensioning the cable pull 28, the band 20 contacts the contact surface 21 of the toothed disk 15 with its belts 23 and is moved relative to the toothed disk 15 in the counterclockwise direction, wherein this band is moved under deflection of the tension spring 27.

In the following, the function of the actuator according to the invention is described. For activating the not-shown parking brakes, the electric motor 1 is activated. Through rotation of the rotor 2 and the threaded spindles 3, spindle nuts 4 are displaced in the axial direction along the threaded spindle 3, that is, in the direction towards the motor housing 1a. Under this displacement of the cable pull support 4a, the cable pulls 8 are tensioned, wherein, as a result of activating the cable pulls 8, the parking brakes are activated. If there is no current flowing to the electric motor 1, the piston 18 of the locking device 11 moves into the closest possible gap 17. The toothed disk 15—and thus the rotor 2—is now engaged and locked in its rotational position.

For releasing the parking brake, first the piston 18 must be moved again out of the gap 17. However, at first this can be made more difficult in that under a torque acting on the toothed disk 15, one of the two teeth adjacent to the piston 18 presses against the piston 18. For relaxing pressure, the electric motor 1 can be activated for a short time or optionally the emergency unlocking device 19 can be activated, if, for example, the electric motor 1 has failed. For this purpose, for example, in the passenger compartment there can be a handle attached to the cable pull 28 in order to be able to pull on the cable pull 28. The band 20 is now pushed under the section of the cable pull 28. The catch 22 of the band 20 shown in FIG. 3 is finally led into a gap 17. For further movement of the band, now the toothed disk 15 is now taken along by means of a positive engagement. Under these positive engagement measures, the piston 18 is now released from pressure. Finally, the pressure is reduced so far that the piston 18 springs back under the spring force and is led out of engagement with the gap 17. Now, the toothed disk 15 can rotate again, that is, also the rotor 2 and the threaded spindle 3. Now, the spindle nuts 4 can be displaced away from the motor housing 1a along the threaded spindle 3 under the relaxing of the cable pulls 8, whereby the parking brakes are released.

### LIST OF REFERENCE SYMBOLS

1 Electric motor
1a Motor housing
2 Rotor
3 Threaded spindle
4 Spindle nut
4a Cable pull support
5 Rolling body
5a Ball
6 Threaded path
7 Threaded path
8 Cable pull
9 Ball screw
10 Ball raceway
11 Locking device
12 Locking element
13 Locking element
14 Electromagnet
15 Toothed disk
16 Tooth
17 Gap
18 Piston
19 Emergency unlocking device
20 Band
21 Contact surface
22 Catch
22a Transverse crosspiece
23 Belt
24 Pocket
25 Housing
26 Connecting member
27 Tension spring
28 Cable pull

1. Actuator for a parking brake of a motor vehicle, comprising an electric motor (1), having a rotor (2) with a threaded spindle (3), on which a spindle nut (4) is arranged, wherein between the threaded spindle (3) and the spindle nut (4) there are rolling bodies (5) in rolling engagement with threaded paths (6, 7) formed on the spindle nut (4) and the threaded spindle (3), and wherein a cable pull (8) engages the spindle nut (4) for activating a brake.

2. Actuator according to claim 1, wherein the threaded spindle (3) is arranged coaxial to the rotor (2) and is provided with a second threaded path section of opposite slope, wherein another spindle nut (4) is arranged on the second threaded path section and wherein another cable pull (8) engages on the second spindle nut (4) so that cable pulls are engaged on each of the spindle nuts.

3. Actuator according to claim 1, wherein ball screws (9) are used, wherein the rolling bodies are formed by balls (5a), which circulate in endless ball raceways (10), which are defined by the threaded paths (6, 7) of the threaded spindle (3) and the spindle nut (4).

4. Actuator according to claim 1, wherein a locking device (11) is provided, which prevents rotation of the rotor (2) and thus the threaded spindle (3) when no current flows to the electric motor (1).

5. Actuator according to claim 4, wherein the locking device (11) has a first locking element (12) fixed in rotation with the rotor (2) and a movable second locking element (13), wherein in a locking position the two locking elements (12, 13) engage each other with a positive fit for preventing rotation of the rotor (2).

6. Actuator according to claim 5, wherein an electromagnet (14) fixed to the frame acts on the second locking element (13), which moves into the locking position through activation of the electromagnet (14).

7. Actuator according to claim 5, wherein the first locking element (12) has a toothed disk (15) fixed in rotation with the rotor (2) and on whose periphery several teeth (16) are distributed having gaps (17) provided therebetween.

8. Actuator according to claim 5, wherein the second locking element has a piston (18) for engagement with the first locking element (12).

9. Actuator according to claim 8, wherein a spring force acts on the piston (18), wherein the piston (18) is moveable against the spring force into the locking position.

10. Actuator according to claim 7, wherein the piston (18) engages in one of the gaps (17) of the toothed disk (15) in the locking position of the locking device (11).

11. Actuator for a parking brake of a motor vehicle, comprising an electric motor (1), having a rotor (2) that drives a control element, wherein a locking device (11) is provided for positive-fit locking of the actuator, and with an emergency unlocking device (19) for relaxing the locking device (11) from a load applied for applying the brakes.

12. Actuator according to claim 11, wherein the emergency unlocking device (19) has a band (20), which is arranged perpendicular to the rotor axis and which wraps around a contact surface (21) arranged coaxial to an axis of the rotor.

13. Actuator according to claim 12, wherein the band (20) is provided with a catch (22) for active engagement with a counter catch (17) locked in rotation to the rotor (2), wherein, in active engagement, the band (20) prevents rotational movement of the rotor (2).

14. Actuator according to claim 13, wherein the band (20) is arranged for movement in a longitudinal direction.

15. Actuator according to claim 13, wherein the rotor (2) is provided with a toothed disk (15), having several teeth (16) distributed over a periphery thereof, the periphery including gaps (17) formed between the teeth, wherein, in active engagement, the catch (22) of the band (20) engages in one of the gaps (17) forming the counter catch.

16. Actuator according to claim 15, wherein the band (20) has a pocket (24), which is defined by a belt (23) arranged in a longitudinal direction of the band (20) and by the catch (22) and in which the teeth (16) of the toothed disk (15) engage.

17. Actuator according to claim 1, wherein a housing (25) of the actuator is provided with a connecting member (26), on which the spindle nut (4) is locked in rotation.

18. Actuator according to claim 11, wherein the control element is formed by a ball screw (9) or other rotary transmission gearing.
